(19) United States
(12) Patent Application Publication
(10) Pub. No.: US 2008/0022307 A1
(43) Pub. Date: Jan. 24, 2008

(54) BROADCAST PROGRAM RECOMMENDATION METHOD AND APPARATUS USING SAID METHOD

(75) Inventors: Jin Guk JEONG, Yongin-si (KR); Eui Hyeon Hwang, Goyang-si (KR); Ji Yeun Kim, Seoul (KR); Sang Kyun Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/768,425

(22) Filed: Jun. 26, 2007

(30) Foreign Application Priority Data
Jul. 19, 2006 (KR) 10-2006-0067445

(51) Int. Cl. G06F 3/00

(52) U.S. Cl. 725/44

(57) ABSTRACT

A broadcast program recommendation method includes: selecting as many broadcast program channels as a number of initial broadcast program recommendations; displaying each broadcast program frame, corresponding to the selected broadcast program channel, as a recommendation screen; and receiving a selection of any one channel from a plurality of the selected broadcast program channels from a user.

### CROSS-REFERENCE TO RELATED APPLICATION

This application claims the benefit of Korean Patent Application No. 10-2006-0067445, filed on Jul. 19, 2006, in the Korean Intellectual Property Office, the disclosure of which is incorporated herein by reference.

### BACKGROUND OF THE INVENTION

1. Field of the Invention

The present invention relates to a broadcast recommendation method and an apparatus using the method. More particularly, the present invention relates to a broadcast recommendation method and an apparatus using the method which can select a desired broadcast program for a user since as many broadcast program channels are selected as a number of initial broadcast program recommendations, and a broadcast program frame corresponding to the selected broadcast program channel is displayed as a recommendation screen.

2. Description of Related Art

Generally, a broadcast receiving apparatus receives broadcast data corresponding to a selected channel when a user selects the channel.

As an example, in a broadcast recommendation method of a conventional broadcast receiving apparatus, a broadcast program including a preferred word is recommended by searching an electronic program guide (EPG) after the user registers the preferred word. Also, as another example, in the broadcast recommendation method of a conventional broadcast receiving apparatus, a broadcast program is recommended using a keyword after extracting the keyword for each broadcast program. Also, as still another example, in the broadcast recommendation method of a conventional broadcast receiving apparatus, an appropriate program is recommended by analyzing a keyword according to a user profile, after extracting a keyword from the EPG information and connecting with the broadcast program.

In the convention broadcast program recommendation method using the EPG or the extracting the keyword, a recommendation of the EPG time unit is possible since a broadcast program is recommended by using only the keyword existing in the EPG. Specifically, the recommendation is possible using a program starting time and a program end time which are included in the EPG. As an example, in a case of broadcast programs whose a broadcasting time is comparatively is longer, e.g. a soccer game, a baseball game, and the like, the recommendation is possible only at a point in time the games start. Also, the user may not check whether the recommendation is a service for recommending a contents of what the user requires since a starting time of the broadcast program using the EPG information may not be a real starting time of the broadcast program, but may be a starting time of a commercial film which is not associated with the desired broadcast program.

Also, as yet another example of the convention broadcast program recommendation method, a picture in picture (PIP) method recommends a broadcast program to a user in the PIP type when a recommendation score is greater than a threshold. However, in the broadcast program recommendation method using the conventional PIP technique, since a section of a screen for a frame of the PIP to be inserted is fixed, the user is interrupted from viewing a broadcast program when the fixed section includes essential information of the broadcast program the user is currently viewing.

### BRIEF SUMMARY

An aspect of the present invention provides a broadcast program recommendation method and an apparatus using the method which can readily select a desired broadcast program channel for a user by selecting as many broadcast program channels as a number of initial broadcast program recommendations, and displaying a broadcast program frame corresponding to the selected broadcast program channel.

An aspect of the present invention also provides a broadcast program recommendation method and an apparatus using the method which can readily select a desired broadcast program channel for a user by selecting a plurality of broadcast program channels using a usage history, and providing the selected broadcast program channel frame as each recommendation screen.

An aspect of the present invention also provides a broadcast program recommendation method and an apparatus using the method which can reduce a broadcast program selection time for a user by helping the user to comparatively quickly select a desired program among broadcast programs from multiple channels.

An aspect of the present invention also provides a broadcast program recommendation method and an apparatus using the method which can readily select a desired broadcast program channel for a user by selecting a plurality of broadcast program channels according to the user's preference, and providing the selected broadcast program frame as each recommendation screen.

An aspect of the present invention also provides a broadcast program recommendation method and an apparatus using the method which can check for an event in real time that has occurred on other broadcast channels, excluding a broadcast channel a user is currently viewing, by selecting a monitoring broadcast channel to provide a service for recommending a broadcast program during viewing of the broadcast program, analyzing a broadcast program corresponding to the selected monitoring broadcast program channel, and recommending a broadcast program for the monitoring broadcast channel according to whether the event is detected or not.

An aspect of the present invention also provides a broadcast program recommendation method and an apparatus using the method which can accurately check a starting time of a user's preferred broadcast program by analyzing a broadcast program on other channels, including a broadcast channel a user is currently viewing.

An aspect of the present invention also provides a broadcast program recommendation method and an apparatus using the method which can readily switch a channel and help not to miss a desired contents by showing, in a type of a PIP, a special event occurring in or the user's favorite broadcast program starting on other channels, when a special event occurs on the other channels, or when the user's favorite broadcast program starts on other the channels, during viewing of a broadcast program selected by the user.

According to an aspect of the present invention, there is provided a broadcast program recommendation method including: selecting as many broadcast program channels as a number of initial broadcast program recommendations; displaying each broadcast program frame, corresponding to the selected broadcast program channel, as a recommendation screen; and receiving a selection of any one channel from a plurality of the selected broadcast program channels from a user.

According to another aspect of the present invention, there is provided a broadcast program recommendation method including: selecting a monitoring broadcast channel to provide a service for recommending a broadcast program for each tuner; detecting an event by analyzing a broadcast program corresponding to the selected monitoring broadcast channel; calculating a location where a broadcast program frame, corresponding to the detected event within a present screen, is to be inserted; and inserting the broadcast program frame corresponding to the detected event into the calculated location.

According to still another aspect of the present invention, there is provided a broadcast program recommendation apparatus including: a broadcast receiving unit receiving a broadcast program frame corresponding to a plurality of broadcast program channels; a channel selection unit selecting a broadcast program channel; a display unit respectively displaying a broadcast program frame corresponding to the broadcast program channel selected by the channel selection unit as a recommendation screen; a user input unit receiving a selection for any one of the broadcast programs which are displayed as the recommendation screen from the user.

According to yet another aspect of the present invention, there is provided a broadcast program recommendation apparatus including: a channel selection unit selecting a monitoring broadcast program channel to provide a service for recommending a broadcast program for each tuner; a broadcast receiving unit receiving broadcast data; an event detection unit detecting an event by analyzing a broadcast program corresponding to the selected monitoring broadcast channel; a calculation unit calculating a location where a sub screen is to be inserted on a main screen, the sub screen displaying the detected event on the main screen; and a display unit inserting the sub screen into the calculated location, and displaying the detected event on the inserted sub screen.

Additional and/or other aspects and advantages of the present invention will be set forth in part in the description which follows and, in part, will be obvious from the description, or may be learned by practice of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The above and/or other aspects and advantages of the present invention will become apparent and more readily appreciated from the following detailed description, taken in conjunction with the accompanying drawings of which:

FIG. 1 is a diagram illustrating a configuration of a broadcast program recommendation apparatus according to an exemplary embodiment of the present invention;

FIG. 2 is a diagram illustrating a configuration of a broadcast receiving unit of FIG. 1;

FIG. 3 is a diagram illustrating a configuration of a tuner scheduling unit of FIG. 2;

FIG. 4 is a diagram illustrating an example of a recommendation screen according to a number of broadcast program recommendations according to an exemplary embodiment of the present invention;

FIG. 5 is a diagram illustrating a configuration of a broadcast program recommendation apparatus according to another exemplary embodiment of the present invention;

FIG. 6 is a diagram illustrating an example of sliding of a spatial window to determine the location where the sub screen is to be inserted, according to an exemplary embodiment of the present invention;

FIG. 7 is a diagram illustrating an example of a broadcast program recommendation screen during viewing a broadcast program, according to an exemplary embodiment of the present invention;

FIG. 8 is a flowchart illustrating a broadcast program recommendation method according to an exemplary embodiment of the present invention;

FIG. 9 is a flowchart illustrating an operation of the displaying the broadcast program frame, corresponding to the selected broadcast program channel, as the recommendation screen, according to the exemplary embodiment of the present invention;

FIG. 10 is a flowchart illustrating an example of the scheduling the tuner, according to the exemplary embodiment of the present invention; and

FIG. 11 is a flowchart illustrating a broadcast program recommendation method according to another exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

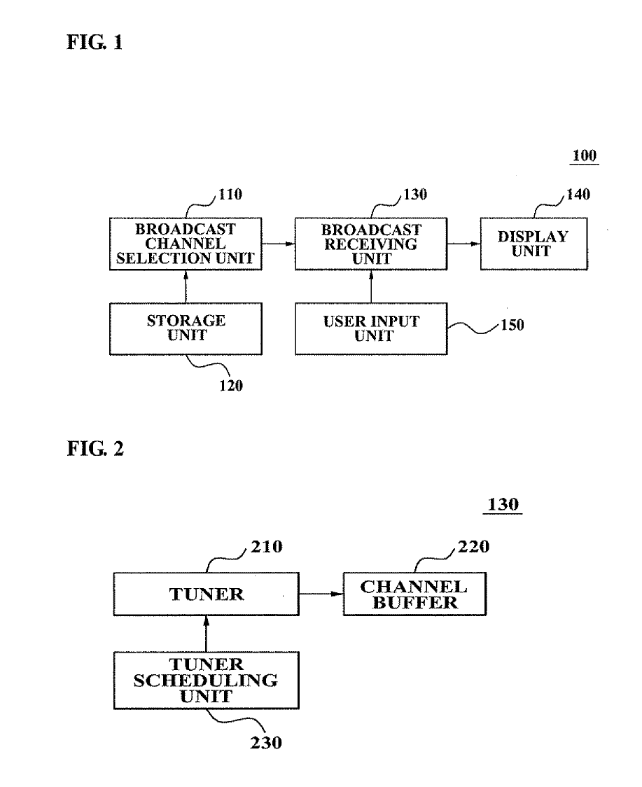

FIG. 1 is a diagram illustrating a configuration of a broadcast program recommendation apparatus 100 according to an exemplary embodiment of the present invention.

Referring to FIG. 1, the broadcast program recommendation apparatus 100 includes a broadcast channel selection unit 110, a storage unit 120, a broadcast receiving unit, a display unit 140, and a user input unit 150.

The broadcast channel selection unit 110 selects as many broadcast program channels as a number of initial broadcast program recommendations. As a non-limiting example, the broadcast channel selection 110 selects nine broadcast program channels when the number of the initial broadcast program recommendation is nine.

The storage unit 120 stores a usage history. For the usage history, channel information, time information and genre information of the broadcast program that a user mainly views, are stored. When there is a plurality of users, the storage unit 120 may store a user's usage history for each user's identification (ID). Also, a main viewer, i.e. a main user, usually exists, therefore, the storage unit 120 stores and manages an entire viewing pattern as a single user's viewing pattern.

The broadcast channel selection unit 110 selects the broadcast program channel as many as a number of the initial broadcast program recommendation using the usage history stored in the storage unit 120. Specifically, for this non-limiting example, the broadcast channel selection unit 110 selects nine broadcast programs in an order of a greatest user's preference for the broadcast program, from among all receivable broadcast program channels, when the stored usage history corresponds to the user's broadcast program preference, and, as another non-limiting example, when a number of all receivable broadcast program channels is thirty and a number of the initial broadcast program recommendations is nine.

The broadcast channel selection unit 110 selects as many broadcast program channels as the number of initial broadcast program recommendations according to a broadcast recommendation score. The broadcast program recommendation score Sᵣ is estimated by Equation 1 below, by utilizing a preference weight for a genre, a preference weight for a program, a viewing time ratio for each genre, and a viewing time for each program of the user.

$${S}_{r} = {\sum }_{i} {w}_{i} {s}_{i} , {\sum }_{i} {w}_{i} = 1 \qquad [ Equation 1 ]$$

In Equation 1, wᵢ indicates a weight, and sᵢ indicates a score.

Examples of the weights and the scores are as follows:

w₀ designates user preference weight for a large genre, e.g. sports, drama, and the like;

w₁ designates user preference weight for a small genre, e.g. baseball, soccer, an action movie, a soap opera, and the like;

w₂ designates user preference weight for programs of sports teams, e.g. Samsung Team game and LG Team game;

s₀ designates viewing time/entire viewing time for each large genre;

s₁ designates viewing time for each small genre/viewing time for each large genre; and

s₂ designates viewing time for each program/viewing time for each small genre.

Another non-limiting example of the weights and scores is as follows:

w₀ designates user preference weight for a genre, e.g. baseball, soccer, an action movie, a soap opera, and the like;

w₁ designates user preference weight for programs of sports teams, e.g. Samsung Team game, Seoul Team game;

s₀ designates viewing time for each genre/entire viewing time; and

s₁ designates viewing time for each program/viewing time for each genre.

The weights may be determined in inverse proportion to a dispersion value of the scores. Specifically, the broadcast program recommendation score may be automatically determined by increasing a weight for the small genre for a viewer, i.e. a user, who equally views a Samsung Team game and an LG Team game, and decreasing a weight for the small genre for a viewer who views only a single type of program.

As described above, the broadcast program recommendation apparatus 100 of the present invention may select to recommend as many broadcast program channels as the number of the initial broadcast programs, according to the genre or the user's preference weight for the broadcast program, or according to the genre or the score by the program viewing time.

Accordingly, the broadcast program recommendation apparatus 100 of the present invention which can readily select a desired program for the user by recommending as many broadcast program channels as the number of the initial broadcast program recommendations according to the user's preference weight and the score at an initial point that the user views the broadcast program.

Still another non-limiting example of the weights and the scores is as follows:

w₀ designates one; and

s₀ designates a number of viewings for each channel at the present time/a total number of viewings at present time.

As described above, the broadcast program recommendation apparatus 100 of the present invention may select to recommend as many broadcast program channels as the number of the initial broadcast program recommendations, in an order of channels whose viewers are greater at the present time, using a ratio of the number of viewings for each channel at the present time to the total number of viewings at present time, without considering the genre or the user's preference weight for the broadcast program.

Accordingly, the broadcast program recommendation apparatus 100 of the present invention may readily select a desired channel for the user, among the plurality of recommended channels, by recommending mostly viewed channels at present time.

The broadcast receiving unit 130 receives a broadcast program frame corresponding to the plurality of broadcast program channels or corresponding to the selected broadcast program channel.

FIG. 2 is a diagram illustrating a configuration of the broadcast receiving unit 130 of FIG. 1.

Referring to FIG. 2, the broadcast receiving unit 130 includes a tuner 210, a channel buffer 220, and a tuner scheduling unit 230. The tuner 210 performs tuning for receiving the broadcast program frame corresponding to the selected broadcast program channel. The channel buffer 220 stores the broadcast program frame, received from the selected broadcast program channel, via the tuner 210. The tuner scheduling unit 230 schedules the tuner 210 according a number of the selected broadcast program channels.

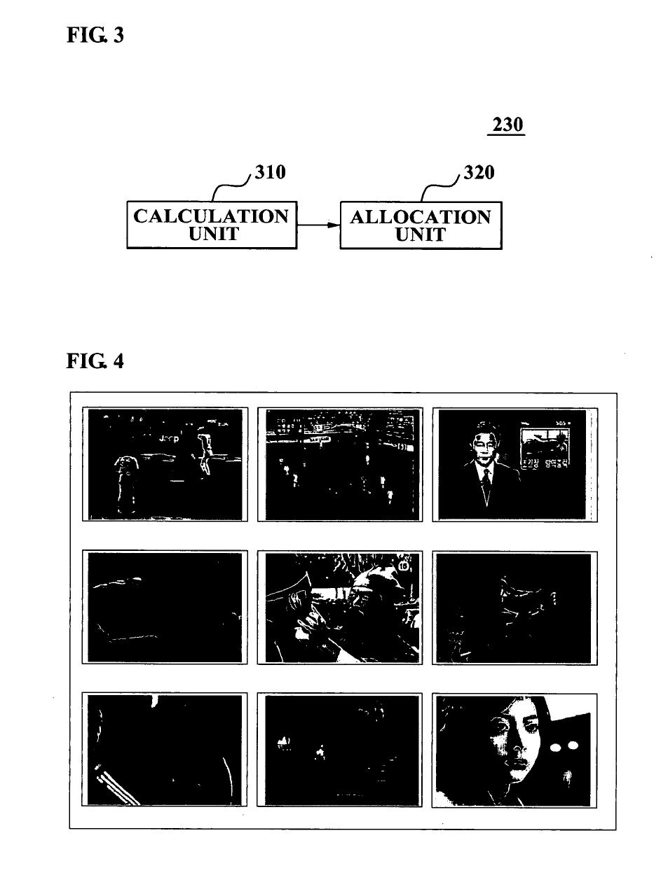

FIG. 3 is a diagram illustrating a configuration of the tuner scheduling unit 230 of FIG. 2.

Referring to FIG. 3, the tuner scheduling unit 230 includes a calculation unit 310 and an allocation unit 320. The calculation unit 310 calculates a number of allocated channels for each tuner 210, and calculates an average value for a difference of the broadcast program frame within the channel buffer. As a non-limiting example, the calculation unit 310 calculates a number of the allocated channel for each of three tuners as three when a number of initial broadcast program recommendations is nine, and when the tuner 210 of FIG. 2 is formed of three tuners. The difference of the broadcast program frame within the channel buffer may be possible in any form, for example, a difference of a Y histogram.

The allocation unit 320 allocates a time slot of the tuner 210 of FIG. 2 within a time window to each broadcast program channel. Specifically, when a time window of one second is divided into ten, the allocation unit 320 may allocate 0.1 second to the each channel, as a single time slot. The broadcast program frame greatly changes when the difference of the broadcast program frame is great, therefore a great number of time slots are allocated to the allocation unit 320. The broadcast program frame changes less when a difference of the broadcast program frame within the each channel buffer is less, and a few number of time slots are allocated to the allocation unit 320.

As described above, the tuner scheduling unit 230 of FIG. 2 may receive a plurality of broadcast channels using one tuner, in order to solve a problem that developing costs increase since when as many of the tuners 210 of FIG. 2 are provided as a number of all the broadcast program channels, an additional tuner 210 of FIG. 2 is required to be provided whenever the broadcast channel increases.

The display unit 140 of FIG. 1 respectively displays the broadcast program frame corresponding to the selected broadcast program channel as a recommendation screen.

FIG. 4 is a diagram illustrating an example of a recommendation screen according to a number of broadcast program recommendations according to an exemplary embodiment of the present invention.

As a non-limiting example, referring to FIG. 4, the display unit 140 respectively displays the broadcast program frame corresponding to nine selected broadcast program channel when the number of the initial broadcast program recommendation is nine, as the recommendation screen.

The user input unit 150 receives a selection for the broadcast program channel from the user, regarding the recommendation screen displayed on the display unit 140 of FIG. 1. The user uses a keypad for input to select the corresponding broadcast program channel via the input unit 150 of FIG. 1 regarding the broadcast program frame corresponding to the current example of nine broadcast program channels which are displayed as the recommendation screen when there is a desired broadcast program channel to view, among the example nine broadcast program channels. When a plurality of users use the broadcast program recommendation apparatus 100, the input unit 150 of FIG. 1 may receive a preferred channel for each user's ID, and may receive a channel for each of the plurality of user's preferences.

The broadcast receiving unit 130 receives the broadcast program corresponding to the selected broadcast program channel, selected via the user input unit 150. The display unit 140 displays the broadcast program corresponding to the selected broadcast program channel which is selected by the user. Also, the user input unit 150 may directly receive the broadcast program channel, which is displayed as the recommendation screen, from the user. As a non-limiting example, when there are four channels that the user mainly views, the user input unit 150 directly receives information of the four broadcast program channels to display as the recommendation screen from the user.

As described above, the broadcast program recommendation apparatus 100 of the present invention may readily select the user's desired broadcast program channel by providing as many broadcast program frame as the number of the initial broadcast program recommendations according to the usage history and the program recommendation score as the recommendation screen, subsequently the user may check the broadcast program frame.

Accordingly, the broadcast program recommendation apparatus 100 of the present invention may reduce costs related to tuners by simultaneously displaying a greater number of broadcast program channels using a fewer number of tuners.

Also, the broadcast program recommendation apparatus 100 of the present invention may reduce a broadcast program selection time for the user by helping the user to comparatively quickly select a desired program among broadcast programs which are spread across multiple channels.

Also, the broadcast program recommendation apparatus 100 of the present invention may check for an event occurring on other broadcast channels in real time, excluding a broadcast channel a user is currently viewing, by selecting a monitoring broadcast channel to provide a service for recommending a broadcast program during viewing of the broadcast program, analyzing a broadcast program corresponding to the selected monitoring broadcast program channel, and recommending a broadcast program for the monitoring broadcast channel according to whether the event is detected or not.

Also, the broadcast program recommendation apparatus 100 of the present invention may more readily select a desired program for the user by simultaneously checking a plurality of programs, including when the user's favorite broadcast programs starts on other channels.

FIG. 5 is a diagram illustrating a configuration of a broadcast program recommendation apparatus 500 according to another exemplary embodiment of the present invention.

Referring to FIG. 5, the broadcast program recommendation apparatus 500 of the present invention includes a channel selection unit 510, a broadcast receiving unit 520, an event detection unit 530, a calculation unit 540, a screen synthesis unit 550, and a display unit 560.

The channel selection unit 510 selects a monitoring broadcast channel to provide a service for recommending a broadcast program for each tuner 210 of FIG. 2. Specifically, the channel selection unit 510 selects the monitoring broadcast channel for monitoring whether a user's preferred genre or program starts or not on other channels during viewing a broadcast program.

The channel selection unit 510 selects as many monitoring broadcast channels as a number of the tuners 210 of FIG. 2, in an order of the monitoring broadcast channel whose recommendation score is greatest for each broadcast program channel, at a new broadcast program's starting point. The starting point of a new broadcast program may be ascertained via the EPG information. Specifically, the channel selection unit 510 selects as many monitoring broadcast channel as the number of the tuners 210 of FIG. 2, in an order of the monitoring broadcast channel with a greatest recommendation score, for the each broadcast program channel, at the point of the new broadcast program's starting point since all channels can not be monitored using a limited number of the tuners 210 of FIG. 2 when the number of the broadcast programs is great. The number of the tuners 210 of FIG. 2 is calculated by one less than the entire number of the tuners 210 since there is one channel that the user is viewing, for example, when the entire number of the tuners 210 of FIG. 2 is three, the number of the tuners 210 of FIG. 2 is two.

The broadcast receiving unit 520 receives broadcast data. Specifically, the broadcast receiving unit 520 receives the broadcast data corresponding to the broadcast program channel currently being displayed on a main screen or the selected monitoring broadcast channel.

The event detection unit 530 detects an event by analyzing the broadcast data for the selected monitoring broadcast channel. The event includes a scene that the user is likely to be interested in, e.g. a starting point of the broadcast program where the user's preference is great, an important event of sports, and a performing scene by a performer where the user's preference is great. The starting point of a broadcast program where the user's preference is great, indicates a point immediately before the broadcast program starts, for example an ending point of a commercial film. The important event of sports indicates a scene, e.g. a homerun scene, a hit scene, and a scoring scene, when the sports is a baseball game, and indicates a corner kick scene, a free kick scene, and a goal scene when the sports is a soccer. The performance scene by a performer where the user's preference is great, indicates a scene, e.g. a scene of the user's favorite singer's performing in a show. Namely, the event detection unit 530 detects the event by analyzing the broadcast program corresponding to the selected monitoring broadcast channel, the event including the starting point of the broadcast program where the user's preference is great, the important event of sports, and the performance scene by the performer where the user's preference is great.

The calculation unit 540 calculates a location where a sub screen, for displaying the detected event, is to be inserted. Specifically, the calculation unit 540 establishes a spatial window corresponding to a size where the detected event is to be displayed, and calculates the appropriate location where the sub screen is to be inserted while sliding the established spatial window on the main screen.

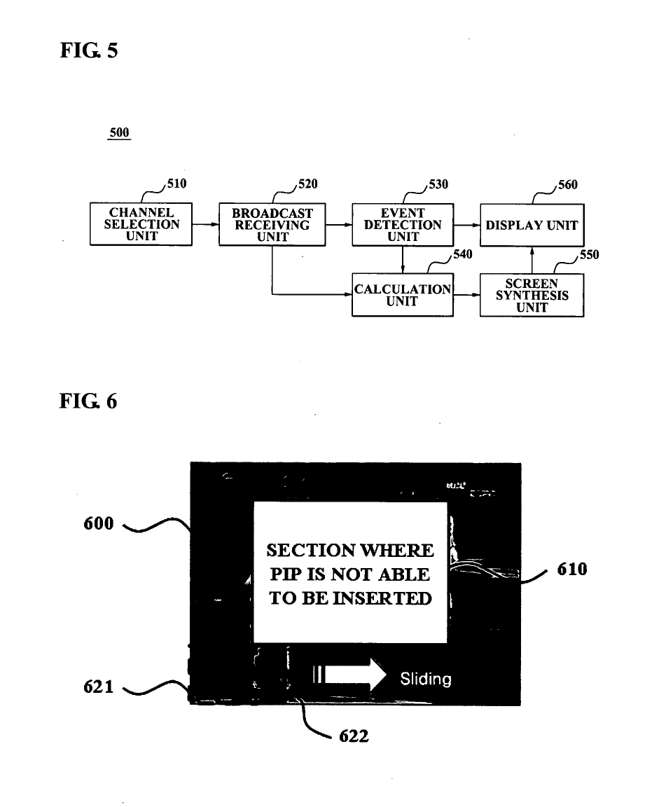

FIG. 6 is a diagram illustrating an example of the sliding of the spatial window to determine the location where the sub screen is to be inserted, according to an exemplary embodiment of the present invention.

Referring to FIG. 6, a display screen 600 indicates an entire section of a display screen where a broadcast program is displayed, a screen section 610 indicates a section where a PIP inserting is impossible, and spatial windows 621 and 622 indicate an example of the sliding of the spatial window on the location where the sub screen can be inserted. A center section of the display screen 600 is defined as an impossible section to be inserted with the PIP in the present specification since an important content is highly likely to be inserted at the center section of the display screen 600.

The calculation unit 540 calculates the appropriateness Sp of the location where the sub screen can be inserted, using the screen complexity within the spatial window, or a degree of the spatial window being separated from the center section, as Equation 2 below.

$${S}_{p} = {α}_{0} {\sum }_{i} {p}_{i} \times log ( \frac{1}{{P}_{i}} ) + {α}_{1} ( \vert x - {m}_{x} \vert + \vert y - {m}_{y} \vert ) \qquad [ Equation 2 ]$$

In Equation 2, α₀, α₁ indicate weight values, (x, y) indicate central coordinates of the spatial window, (mₓ, m_{y}) indicates a central coordinates of an entire frame, pᵢ indicates a probability of each bin in a Y histogram. Other color expression method may be used, such as Hue Saturation Value (HSV) or red green blue (RGB), instead of the Y histogram.

The calculation unit 540 may calculate the appropriateness Sp of the location where the sub screen can be inserted as being greater, when the screen complexity within the spatial window is less and/or when the degree of the spatial window being separated from the center section is greater. Namely, the less entropy of the spatial window, and the farther from the center the spatial window is, the appropriateness Sp of the location where the sub screen can be inserted becomes greater. Also, the less an edge density of the spatial window is, and the farther from the center the spatial window is, the appropriateness Sp of the location where the sub screen can be inserted becomes greater. The calculation unit 540 may calculate the edge density using the Sobel edge detector. The screen synthesis unit 550 synthesizes a display screen using the PIP, i.e. the sub screen is inserted into an optimal location according the calculated appropriateness on the main screen. Specifically, the screen synthesis unit 550 selects to insert the sub screen into a location whose appropriateness is the greatest, the location being calculated with its appropriateness on the main screen by the calculation unit 540, and synthesizes the display screen by sub-sampling the broadcast program frame as many times as can be inserted into the sub screen. In this instance, the inserting of the frame may be implemented as a transparent type using an alpha channel, or may be implemented in an obscure type, replacing an original pixel value with a pixel value of the frame.

The display unit 560 displays a currently viewed broadcast program via the main screen, and displays the detected event via the sub screen.

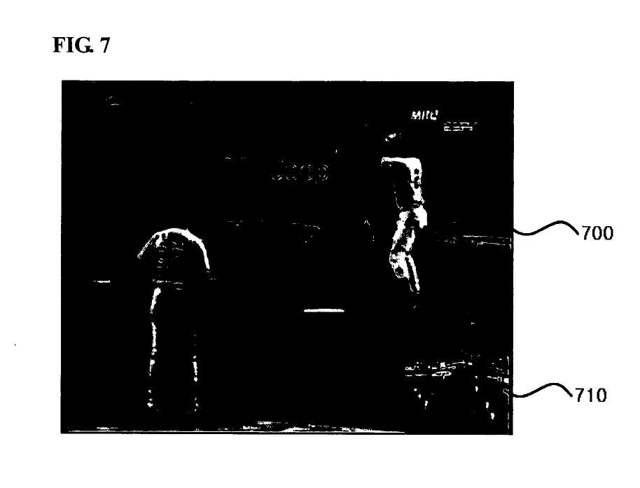

FIG. 7 is a diagram illustrating an example of a broadcast program recommendation screen during viewing a broadcast program, according to an exemplary embodiment of the present invention.

Referring to FIG. 7, a main screen 700 indicates a main screen displaying a currently viewed broadcast program by a user, and a sub screen 710 indicates a sub screen displaying an event occurring in the monitoring broadcast channel. The display unit 560 displays a baseball game broadcast channel via the main screen 700, i.e. the user's currently viewed broadcast program, and displays an event of a goal in scene via the sub screen when the event of the goal in the scene is detected in a soccer game broadcast channel, i.e. in the monitoring broadcast channel.

As described above, the broadcast program recommendation apparatus 500 detects an event occurring on other channels, or detects the user's favorite broadcast program starting on other channel, during viewing of a broadcast program selected by the user, and displays the detected event as a recommendation screen on the present broadcast screen.

Accordingly, the broadcast program recommendation apparatus 500 readily switches a channel and helps the user to not miss desired contents by showing a special event occurring in other channels, or by showing the user's favorite broadcast program starting on other channels, in a type of the PIP, when a special event occurs on other channels, or when the user's favorite broadcast program starts on other channels, while viewing a broadcast program selected by the user.

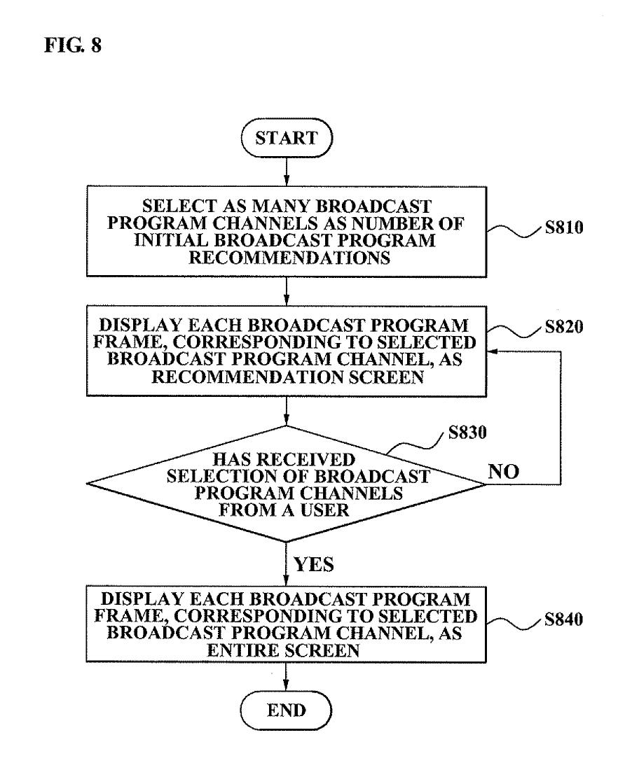

FIG. 8 is a flowchart illustrating a broadcast program recommendation method according to an exemplary embodiment of the present invention.

Referring to FIG. 8, a broadcast program recommendation method selects as many broadcast program channels as a number of initial broadcast programs in operation S810. Namely, the broadcast program recommendation method selects as many broadcast program channels as the number of the initial broadcast program recommendations according to a usage history or a broadcast program recommendation score. The broadcast program recommendation score reflects a user's preference for a program, a length of a user's viewing time for a program, or a number of a user's viewing for each channel at present time. The user's preference may be divided into a large genre, a small genre, a program, and the like.

As an example, in operation S810, the broadcast program recommendation method may select nine broadcast program channels according to the usage history or the broadcast program recommendation score when the number of the initial broadcast program recommendation is nine.

The broadcast program recommendation method respectively displays a broadcast program frame corresponding to the selected broadcast program channel as a recommendation screen in operation S820. Specifically, in operation S820, the broadcast program recommendation method respectively displays the broadcast program frame corresponding to the nine selected broadcast program channels when the number of the initial broadcast program recommendation is nine, as the recommendation screen.

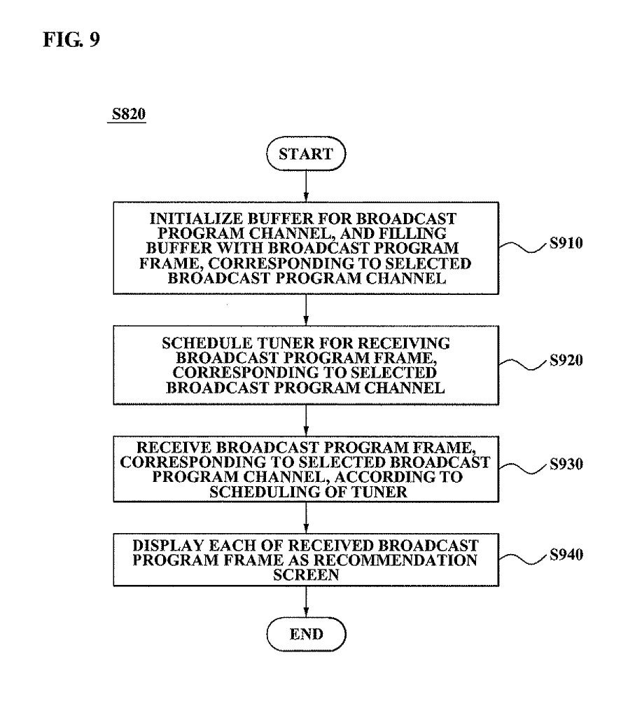

FIG. 9 is a flowchart illustrating an operation of the displaying the broadcast program frame which corresponds to the selected broadcast program channel, as the recommendation screen, according to the exemplary embodiment of the present invention.

Referring to FIG. 9, the broadcast program recommendation method initializes a buffer for the broadcast program channel, and fills the buffer with the broadcast program frame which corresponds to the selected broadcast program channel in operation S910.

The broadcast program recommendation method schedules a tuner to receive the broadcast program frame which corresponds to the selected broadcast program channel in operation S920. Specifically, in operation S920, the broadcast program recommendation method schedules the tuner to receive the broadcast program frame which corresponds to a plurality of broadcast program channels using one tuner. In the conventional art, as an example, nine tuners are required to simultaneously display the broadcast program frame as illustrated in FIG. 4, which are received via the nine selected broadcast program channel, subsequently costs increase since as many tuners as the number of the broadcast program channels are provided. Accordingly, the broadcast program recommendation method schedules the tuner to simultaneously display a greater number of the broadcast program channels using a fewer number of tuners.

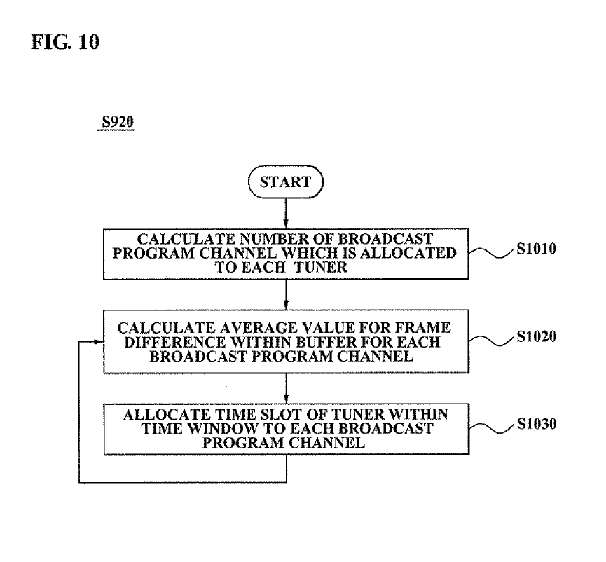

FIG. 10 is a flowchart illustrating an example of the scheduling the tuner, according to the exemplary embodiment of the present invention.

Referring to FIG. 10, the broadcast program recommendation method calculates a number of the broadcast program channels which are allocated to each tuner in operation S1010. Specifically, when the broadcast program recommendation method is required to receive the nine broadcast program channel, and when a number of provided tuners is three, a number of allocated broadcast program channels for each tuner is three.

The broadcast program recommendation method calculates an average value for a difference of the broadcast program frame within a buffer for each broadcast program channel in operation S1020. A difference of a Y histogram may be utilized for the difference of the broadcast program frame within the channel buffer.

The broadcast program recommendation method allocates a time slot of the tuner within a time window to each broadcast program channel by referring to the calculated average value for the difference of the broadcast program frame in operation S1030. Specifically, when a time window of one second is divided into ten, 0.1 second may be established as a single time slot. Specifically, the broadcast program frame greatly changes when the difference of the broadcast program frame is great, therefore the broadcast program recommendation method allocates a great number of time slots to a corresponding broadcast program channel in operation S1030. As an example, when three channels A, B and C are allocated to a single tuner, and when an average value for a difference of the broadcast program frame A is thirty, an average value for a difference of the broadcast program frame B is twenty, an average value for a difference of the broadcast program frame C is ten, the broadcast program recommendation method allocates the time slots for each broadcast program channel in a 3:2:1 proportion.

As the broadcast program recommendation method repeatedly performs the operations S1020 and S1030 for a subsequent time window, an allocated time slot may change.

As described above, the broadcast program recommendation method of the present invention allocates the time slot in proportion to the difference of the broadcast program frame, and fills the buffer with the broadcast program frame which corresponds to the selected broadcast program channel in every time slot.

The broadcast program recommendation method receives a broadcast program frame corresponding to the selected broadcast program channel according to the scheduling of the tuner in operation S930.

The broadcast program recommendation method respectively displays the received broadcast program frame as the recommendation screen in operation S940.

The broadcast program recommendation method determines whether the broadcast program channel which corresponds to the broadcast program frame, displayed as the recommendation screen, is selected or not by the user in operation S830. After confirming the broadcast program frame, displayed as the recommendation screen, the user selects a corresponding channel when the broadcast program frame corresponds to the user's desired broadcast program.

When the broadcast program channel is selected by the user, the broadcast program recommendation method displays a broadcast program corresponding to the selected broadcast program channel on an entire screen in the operation S840.

As described above, the broadcast program recommendation method may reduce a broadcast program selection time for a user by helping the user to comparatively quickly select a desired program among broadcast programs which are multi channeled.

Also, the broadcast program recommendation method may more readily select a desired program for the user by simultaneously checking a plurality of programs, i.e. the user's favorite broadcast program.

Also, the broadcast program recommendation method may reduce costs for tuners the tuner by simultaneously displaying a greater number of the broadcast program channels using a fewer number of the tuners.

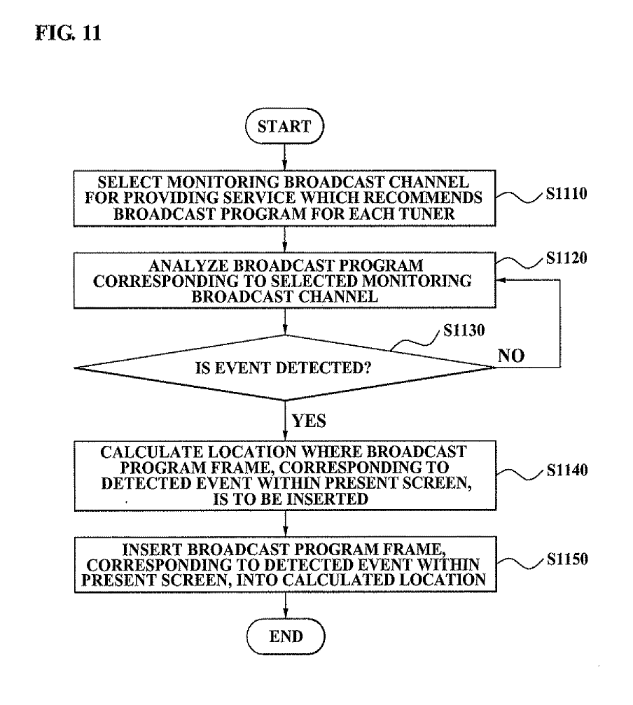

FIG. 11 is a flowchart illustrating a broadcast program recommendation method according to another exemplary embodiment of the present invention.

Referring to FIG. 11, the broadcast program recommendation apparatus selects a monitoring broadcast program channel to provide a service for recommending a broadcast program for each tuner in operation S1110. The monitoring broadcast channel includes a broadcast channel displaying a genre or a program whose a user's preference is great among other channels, excluding the user's currently viewed broadcast program channel. Namely, the broadcast program recommendation apparatus selects as many monitoring broadcast channels as a number of tuners, in an order of the monitoring broadcast channel whose recommendation score is greatest for each broadcast program channel in the operation S1110.

Accordingly, the broadcast program recommendation method of the present invention may monitor whether the user's favorite program or genre is displayed on other broadcast channels or not, including on the broadcast channel the user is currently viewing.

The broadcast program recommendation apparatus analyzes a broadcast program corresponding to the selected monitoring broadcast program channel in operation S1120.

The broadcast program recommendation apparatus determines whether an event is detected or not as a result of the analyzing the broadcasting program corresponding to the selected monitoring broadcast program channel in operation S1130.

The event includes a starting point of the broadcast program where the user's preference is great, an important event of sports, and a performance scene by a performer where the user's preference is great. Namely, the broadcast program recommendation apparatus determines whether the event is detected or not, the event including the starting point of the broadcast program where the user's preference is great, the important event of sports, and the performing scene by a performer where the user's preference is great, as the result of the analyzing of the broadcasting program corresponding to the selected monitoring broadcast program channel.

When the event is detected, the broadcast program recommendation apparatus calculates a location where a broadcast program frame, corresponding to the detected event within a present screen, is to be inserted in operation S1140. Namely, in operation S1140, the broadcast program recommendation apparatus establishes a spatial window corresponding to a size where the detected event is to be displayed, and calculates an appropriate location where the broadcast program frame is to be inserted while sliding the established spatial window on the present screen. As illustrated in FIG. 6, in operation S1140, the broadcast program recommendation apparatus calculates the appropriate location where the broadcast program frame is to be inserted while sliding the established spatial window on the present screen a section 610, excluding where a PIP inserting is impossible, i.e. a center of the present screen. In operation S1140, the broadcast program recommendation apparatus calculates the appropriate location where screen complexity is least in the spatial window and whose section is farthest from the center of the present screen, as the appropriate location being where the broadcast program frame corresponding to the detected event is to be inserted. The screen complexity may be ascertained by entropy or an edge density. As an example, screen complexity of sports broadcast programs, e.g. a soccer game, a baseball game, and the like, is comparatively greater since a section far from the center includes score information, therefore the section far from the center is not appropriate for the location where the broadcast program frame to be inserted. Conversely, a section whose screen complexity is less and a section whose degree of being farther from the center of the present screen are appropriate for the location where the broadcast program frame to be inserted since a probability is comparatively lower that essential information is included in the section.

The broadcast program recommendation apparatus inserts the broadcast program frame corresponding to the detected event into the calculated location on the present screen in operation S1150. Specifically, as described with reference to FIG. 7, in operation S1150, the broadcast program recommendation method inserts a broadcast program frame 710 corresponding to the detected event into a section which does not include the essential information on the present screen 700.

As described above, the broadcast program recommendation method of the present invention detects an event occurring on other broadcast program channels, while the user is currently viewing the broadcast program channel, and provides a recommendation screen by calculating the appropriate location where the broadcast program frame is to be inserted.

Accordingly, the broadcast program recommendation method of the present invention may accurately check when the event occurs on other channels, including on a broadcast channel a user is currently viewing, the event including a starting point of the broadcast program where the user's preference is great, an important event of sports, and a performance scene by a performer where the user's preference is great.

Also, the broadcast program recommendation method according to the other embodiment of the present invention may readily switch a channel and help the user to not miss desired contents by showing a special event occurring on other channels in a type of a PIP, when a special event occurs on other channels, or when the user's favorite broadcast program starts on other channels, while viewing a broadcast program selected by the user.

Also, the broadcast program recommendation method according to the other embodiment of the present invention may quickly check for an event occurring on other channels without interruption of a currently viewed broadcast program, since a broadcast recommendation screen is inserted, in a type of a PIP, into a section having least information within a present screen by analyzing a currently viewed screen on other channels when an event occurs on other channels.

The broadcast program recommendation method according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, there is provided a broadcast program recommendation method and an apparatus using the method which can readily select a desired broadcast program channel for a user by selecting as many broadcast program channels as a number of initial broadcast program recommendations, and displaying a broadcast program frame corresponding to the selected broadcast program channel.

Also, according to the present invention, there is provided a broadcast program recommendation method and an apparatus using the method which can reduce a broadcast program selection time for a user by helping the user to comparatively quickly select a desired program among broadcast programs from multiple channels.

Also, according to the present invention, there is provided a broadcast program recommendation method and an apparatus using the method which can easily select a desired broadcast program channel for a user by simultaneously checking a plurality of programs which are frequently viewed by the user.

Also, according to the present invention, there is provided a broadcast program recommendation method and an apparatus using the method which can reduce costs for tuners since a plurality of channels are viewed using a fewer number of tuners.

Also, according to the present invention, there is provided a broadcast program recommendation method and an apparatus using the method which can accurately check a starting time of a user's preferred broadcast program by analyzing a broadcast program on other channels, including on a broadcast channel a user is currently viewing.

Also, according to the present invention, there is provided a broadcast program recommendation method and an apparatus using the method which can readily switch a channel and help the user to not miss desired contents by showing a special event occurring on other channels, in a type of a PIP, when a special event occurs on other channels, or when the user's favorite broadcast program starts on other channels, during viewing of a broadcast program selected by the user.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. A broadcast program recommendation method comprising:
selecting as many broadcast program channels as a number of initial broadcast program recommendations;
displaying each broadcast program frame, corresponding to the selected broadcast program channel, as a recommendation screen; and
receiving a selection of any one channel from a plurality of the selected broadcast program channels from a user.

2. The method of claim 1, wherein the selecting of the broadcast program channel selects as many of the broadcast program channels as the number of the initial broadcast program recommendations according to a usage history and/or a program recommendation score.

3. The method of claim 2, wherein the program recommendation score reflects the user' program preference, the user's program view time, and the user's program view number for each channel at the present time.

4. The method of claim 1, wherein the displaying each broadcast program frame comprises:
initializing a buffer for the broadcast program channel, and filling the buffer with the broadcast program frame, corresponding to the selected broadcast program channel;
scheduling a tuner to receive the broadcast program frame corresponding to the selected broadcast program channel;
receiving the broadcast program frame, corresponding to the selected broadcast program channel, according to the scheduling of the tuner; and
displaying each of the received broadcast program frames as the recommendation screen.

5. The method of claim 4, wherein the scheduling of the tuner for receiving the broadcast program frame comprises:
calculating a number of broadcast program channels which is allocated to each tuner;
calculating an average value for a difference of the broadcast program frame within the buffer for each broadcast program channel; and
allocating a time slot of the tuner within a time window to each broadcast program channel by referring to the calculated average value for the difference of the broadcast program frame.

6. A broadcast program recommendation method comprising:
selecting a monitoring broadcast channel to provide a service for recommending a broadcast program for each tuner;
detecting an event by analyzing a broadcast program corresponding to the selected monitoring broadcast channel;
calculating a location where a broadcast program frame, corresponding to the detected event within a present screen, is to be inserted; and
inserting the broadcast program frame corresponding to the detected event into the calculated location.

7. The method of claim 6, wherein the selecting the monitoring broadcast channel selects as many monitoring broadcast channels as a number of the tuners, in an order of a greatest program recommendation score for each broadcast channel.

8. The method of claim 6, wherein the event comprises a starting point of a broadcast program whose a user's preference is great, an important event of sports, and a performance scene by a performer whose the user's preference is great.

9. The method of claim 6, wherein the calculating the location comprises:
establishing a spatial window corresponding to a size where the detected event to be displayed; and
calculating an appropriate location where the broadcast program frame corresponding to the detected event is to be inserted, while sliding the established spatial window on the present screen.

10. The method of claim 9, wherein the calculating the appropriate location calculates the appropriate location in a section excluding a center section of the present screen, the appropriate location being where the broadcast program frame corresponding to the detected event is to be inserted, while sliding the established spatial window on the present screen.

11. The method of claim 9, wherein the calculating the appropriate location calculates the appropriate location whose screen complexity is least in the spatial window and whose section is farthest from the center of the present screen, the appropriate location being where the broadcast program frame corresponding to the detected event is to be inserted, while sliding the established spatial window on the present screen.

12. The method of claim 11, wherein the screen complexity is ascertained by entropy or an edge density.

13. A computer-readable storage medium storing a program for implementing a method of broadcast program recommendation method, the method including;
selecting as many broadcast program channels as a number of initial broadcast program recommendations;
displaying each broadcast program frame, corresponding to the selected broadcast program channel, as a recommendation screen; and
receiving a selection of any one channel from a plurality of the selected broadcast program channels from a user.

14. A broadcast program recommendation apparatus comprising:
a broadcast receiving unit receiving a broadcast program frame corresponding to a plurality of broadcast program channels;
a channel selection unit selecting a broadcast program channel;
a display unit respectively displaying a broadcast program frame corresponding to the broadcast program channel selected by the channel selection unit as a recommendation screen;
a user input unit receiving a selection for any one of the broadcast programs which are displayed as the recommendation screen from the user.

15. The apparatus of claim 14, wherein the broadcast receiving unit comprises:
a tuner performing unit performing a tuning operation for receiving a broadcast program corresponding to an allocated channel of the selected broadcast program channels;
a channel buffer storing the received broadcast program frame according to the broadcast program channel tuned by the tuner; and
a tuner scheduling unit scheduling the tuner according to a number of the selected broadcast program channel.

16. The apparatus of claim 15, wherein the tuner scheduling unit comprises:
a calculation unit calculating a number of channels which is allocated to each of the tuners; and
an allocation unit allocating a time slot of the tuner within a time window to each broadcast program channel.

17. The apparatus of claim 14, wherein the channel selection unit selects as many broadcast program channels as a number of initial broadcast program recommendations, according to a use history and a program recommendation score.

18. A broadcast program recommendation apparatus comprising:
a channel selection unit selecting a monitoring broadcast program channel to provide a service for recommending a broadcast program for each tuner;
a broadcast receiving unit receiving broadcast data;
an event detection unit detecting an event by analyzing a broadcast program corresponding to the selected monitoring broadcast channel;
a calculation unit calculating a location where a sub screen is to be inserted on a main screen, the sub screen displaying the detected event on the main screen; and
a display unit inserting the sub screen into the calculated location, and displaying the detected event on the inserted sub screen.

19. The apparatus of claim 18, wherein the channel selection unit selects as many monitoring broadcast program channels as a number of tuners, in an order of a greatest program recommendation score for each broadcast channel.

20. The apparatus of claim 18, wherein the event detection unit detects a starting point of a broadcast program whose user's preference is great, an important event of sports, and a performance scene by a performer whose user's preference is great, by analyzing the broadcast program corresponding to the selected monitoring channel.

21. The apparatus of claim 18, wherein the calculation unit establishing a spatial window corresponding to a size where the detected event is to be displayed; and calculating an appropriate location where the sub screen is to be inserted, while sliding the established spatial window in a main screen.

22. The apparatus of claim 19, wherein the calculation unit calculates the location whose screen complexity is least in the screen and whose section is farthest from a center of the main screen, as the appropriate location where the sub screen is to be inserted.
